(19) United States
(12) Patent Application Publication
(10) Pub. No.: US 2022/0350110 A1
(43) Pub. Date: Nov. 3, 2022

(54) FOCUS SYSTEM AND METHOD FOR OPERATING A FOCUS SYSTEM

(71) Applicant: Optotune AG, Dietikon (CH)

(72) Inventors: Manuel Aschwanden, Dietikon (CH); Stephan Smolka, Dietikon (CH); Johannes Haase, Dietikon (CH)

(73) Assignee: Optotune AG, Dietikon (CH)

(21) Appl. No.: 17/734,070

(22) Filed: May 1, 2022

(30) Foreign Application Priority Data
Apr. 30, 2021 (IB) PCT/IB2021/053638

(51) Int. Cl. G02B 7/38; G02B 3/00; G02B 7/04; G02B 7/02; H04N 5/232

(52) U.S. Cl. CPC G02B 7/38; G02B 3/0056; G02B 7/04; G02B 7/021; H04N 5/23212

(57) ABSTRACT

Focus system (1) comprising an imaging objective (10) with an optical element (100), two emitters (20) for emitting a beam (200) respectively, wherein the imaging objective (10) is arranged to depict an object (3) located in an object plane (30) in an image plane (31), the optical element is arranged to adjust a distance (300) from the object plane (30) to the imaging objective (10), the beams (200) are transmitted through or reflected by the optical element (20), and the beams (200) intersect at the object plane (30).

### CROSS-REFERENCE TO RELATED APPLICATIONS

This application claims the benefit of International Patent Application No. PCT/IB2021/053638, filed Apr. 30, 2021, the contents of which are incorporated by reference in their entirety.

### FIELD

The present disclosure concerns a focus system and a method for operating a focus system.

### BACKGROUND

A focus system described herein is based on the following considerations, among others most focusing systems require objects providing high contrast to reliably adjust the focus. Alternatively additional sensing units may be arranged to determine the object's distance to the imaging objective, wherein the focus is arranged to the distance determined by means of the sensing unit. Such additional sensing units require calibration and adjustment to the imaging objective.

A focus system described herein now makes use of the idea to transmit two beams through the imaging objective or a portion of the imaging objective, so that the beam intersects the image plane at a predefined position and/or the beams intersect in the object plane. The beam or the beams create spots on a surface of the object to be imaged. If the spots overlap, in particular in a congruent manner, or if the spot is detected in the predefined position within the field of view, the said surface is arranged in the object plane of the imaging objective.

Advantageously the overlap or position of the spot(s) is an indicator for the imaging system to be in focus, which is particularly simple to detect. In particular, the focus system is arranged to detect the position of the spot within the field of view. Preferably the focus system is arranged to adjust the distance of the object plane to the imaging objective depending on the detected position of the spot in the field of view or depending on the distance of the multiple spots detected in the field of view.

### SUMMARY

The focus system is arranged to adjust the focus of an imaging objective. The imaging objective has a field of view and the imaging objective is arranged to depict an object located in an object plane within the field of view in an image plane. When adjusting the focus of the imaging objective, the distance from the object plane to the imaging objective is adjusted, in particular the distance from the object plane to the image plane is adjusted. In particular, the focus is adjustable by means of an optical element. The optical element is arranged to adjust the distance from the object plane to the imaging objective.

The optical element may be a reflective or a refractive optical element. For example, the optical element is a mirror, a prism or a lens, which is movable along the optical axis of the imaging objective. In particular, the optical element may be a tunable optical element having an adjustable optical power, wherein the focus of the objective is adjusted by altering the optical power of the optical element.

The focus system comprises an emitter for emitting a beam. In particular the focus system may comprise two emitters for emitting a beam respectively. The beam(s) consist(s) of collimated electromagnetic radiation, preferably in a wavelength range between 200 nm and 1200 nm. The emitter(s) may be (a) laser(s), for example (a) laser diode(s), in particular (a) VCEL(s) or (a) light guide(s) emitting coherent light.

The beam or the beams is/are transmitted through or reflected by the optical element respectively. The optical element is part of the imaging objective. The optical element interacts with both the electromagnetic radiation which creates the image of the object plane and the beams which are emitted by the two emitters. In particular, the optical element is arranged to deflect the beams, wherein the deflection of the beams depends on the distance from the object plane to the imaging objective. By adjusting the distance from the object plane to the imaging objective, the deflection of the beams is altered.

The beam intersects the object plane at a predefined position within the field of view.

In case the focus system comprises multiple emitters, the emitters are arranged such, that the beams intersect at the object plane after interacting with the optical element.

According to one embodiment, the focus system comprises the imaging objective with the optical element and the field of view. The focus system further comprises the emitter for emitting a beam, wherein the imaging objective is arranged to depict the object located in the object plane in the image plane. The optical element is arranged to adjust the distance from the object plane to the imaging objective. The beam is transmitted through or reflected by the optical element, and the beam intersects the object plane at a predefined position within the field of view.

According to one embodiment, the focus system comprises the imaging objective with the optical element, and two emitters which are arranged to emit a beam respectively. The imaging objective is arranged to depict the object located in the object plane in the image plane. The optical element is arranged to adjust the distance from the object plane to the imaging objective. The beams are transmitted through or reflected by the optical element, and the beams intersect at the object plane.

According to one embodiment, the beams have different properties, wherein the beams are distinguishable by the property the beams differ in. In particular, also the reflected portions of the beams may be distinguished by the property. For example, the property is the modulation of the intensity of the beams over time. At least one of the beams may be pulsed, whereby the beams and their reflected portions may be distinguished by their intensity at a certain point in time. Alternatively, the beams may be distinguishable by their respective wavelength. Advantageously, having distinguishable beams allows to determine if the distance from the object plane to the imaging objective is too large or too small Thus, different properties of the beams enable an accelerated adjustment of the optical power.

According to one embodiment, the beams are collimated and a diameter of the aperture of the imaging objective is at least two times, preferably at least hundred times, larger than a diameter of the beams respectively.

According to one embodiment, the focus system comprises an image sensor which is arranged to capture the object depicted in the image plane by means of the imaging objective. The image sensor may be a CMOS sensor or a CCD sensor. The beams impinge on a surface of the object and a reflected portion of the beams is reflected diffusely at the surface of the object. The reflected portions are conceivable at as spots on the surface of the object. In particular, the image sensor is arranged to detect the diffusely reflected portions of the beams which is imaged through the imaging objective. A control unit is arranged to determine a distance between the spots in a lateral direction, wherein the lateral direction is measured in parallel to the object plane. The control unit is arranged to control the optical element. In particular, the control unit controls the optical element such that the distance of the spots becomes zero, in particular, the spots overlap.

According to one embodiment, the image sensor is arranged to detect reflected portions of the beams respectively, which are reflected at the object towards the image sensor.

According to one embodiment the focus system comprises a control unit, wherein the control unit is arranged to determine if the reflected portions of the beams overlap. In particular, the control unit comprises a detection algorithm, which is arranged to detect the spots in the image captured by means of the image sensor. The control unit may be arranged to detect the spots by means of an intensity distribution, a wavelength, a frequency modulation and/or an intensity modulation.

According to one embodiment, the optical element is a tunable lens having a tunable optical power, wherein the distance from the object plane to the imaging objective is adjustable by tuning the optical power. In particular, a distance from the object plane to the image plane is adjustable by means of the tunable lens. The tunable lens may comprise a cavity which is filled with a transparent liquid material. On one side the cavity is delimited by means of a flexible membrane. The flexible membrane defines a shape of a refractive surface of the tunable lens. The optical power of the tunable lens is adjustable by adjusting a curvature of the flexible membrane.

According to one embodiment, the beams propagate symmetrically with respect to an optical axis of the optical element. In particular, the beams propagate symmetrically with respect to the optical axis of the imaging objective. For example, the emitters are arranged symmetrically with respect to the optical axis of the imaging objective.

The imaging objective may comprise an optical unit and the optical element. The optical unit may comprise multiple lenses, mirrors and/or prisms. The imaging objective is arranged to depict the object in the image plane by means of the optical unit and the optical element. The beam path of the beams extends away from the image plane towards the object plane, wherein the beams interact with the optical element at least. In particular, the beams interact with the optical unit. The beam path of the image which is captured by means of the image sensor extends away from the object plane towards the image plane.

The emitters may be arranged between the image plane and the object plane. According to a first alternative, the emitters are arranged between the optical element and the optical unit, wherein the beams interact with the optical element before impinging on the object. In particular, the beams do not interact with the optical unit before impinging on the object.

According to a second alternative, the beams interact with the optical element and the optical unit. For example, the emitters are arranged such that the beams propagate along a propagation line respectively. The propagation lines are imaginary beam paths extending from the image plane to the object plane. The propagation lines intersect at the image plane. A beam angle between the propagation lines is larger than zero degrees, preferably at least 0.01° , and smaller than twice a maximal half-angle of a cone of light that can enter or exit the imaging objective. In particular, the beam angle is smaller than the numerical aperture of the imaging objective. At the image plane, both propagation lines have a same angle with respect to the optical axis of the imaging objective. In particular, the angle between the propagation lines and the optical axis at the image plane is half of the beam angle respectively.

In particular, the emitters may be integrated into the image sensor. Thus, the emitters are arranged in the image plane.

In particular, the focus system may comprise a second image plane, which is generated by means of a beam splitter, wherein the beam splitter is arranged between the imaging objective and the image sensor. In particular, the beams are coupled into the imaging objective from a direction of the second image plane and the image is captured at the image plane. For example, the total track length in the focus system to the image plane and to the second image plane is identical. In particular, no refractive elements are arranged between the beam splitter and the image plane and between the beam splitter and the second image plane.

According to one embodiment the optical element comprises a lens array with multiple lenses, and two emitters are assigned to each lens. In particular, the emitters are optical fibers, which are arranged to emit collimated light, respectively. The light which is emitted by the emitters traverses the lens which is assigned to the emitters, respectively. In particular, the lenses have an adaptive optical power. For example, the optical power of the tunable lenses may be adapted individually.

A method for operating a focus system is further disclosed. In particular, the method can be used to operate a focus system described herein. This means that all features disclosed for the focus system are also disclosed for the method and vice versa.

The method for operating a focus system concerns a focus system comprising an imaging objective with an optical element, wherein the imaging objective is arranged to depict an object located in an object plane in an image plane. The focus system comprises an emitter for emitting a collimated beam, wherein the optical element interacts with the beam by transmission or reflection. The beam intersects the object plane at a predefined position, and the optical element is arranged to adjust a distance from the object plane to the imaging objective. The method comprises a method step a) of emitting the collimated beam by means of the emitter, wherein the collimated beam propagates through the optical element or is reflected at the optical element. The beam impinges on a surface of the object and the beam is reflected diffusely at the surface of the object, wherein the diffusely reflected portion of the beam propagates through the imaging objective, in particular through the optical element, towards an image sensor. The diffusely reflected portion is perceived as a spot on the surface of the object. In a method step b) the position of the reflected portion is detected by means of the image sensor. In a method step c) an actual position of the reflected portion by means of a control unit is determined and the distance from the object plane to the imaging objective is adjusted by means of the optical element to minimize a difference between the actual position and the predefined position.

According to one embodiment the method for operating a focus system concerns a focus system comprising an imaging objective with an optical element, two emitters and an image sensor. The imaging objective is arranged to depict the object located in the object plane in the image plane. The emitters are arranged to emit a collimated beam respectively. The beams interact with the optical element by reflection or transmission. The beams intersect at the object plane. The optical element is arranged to adjust a distance from the object plane to the imaging objective, by moving the optical element or by altering an optical property of the optical element.

The method comprises a method step a) in which collimated beams are emitted by means of the emitters, wherein the collimated beams propagate through the optical element or are reflected at the optical element. The beams impinge on a surface of the object and the beams are reflected diffusely at the surface of the object. In particular, the beams create a spot on the surface of the object. The diffusely reflected portions of the beams propagate through the imaging objective, in particular through the optical element, to the image sensor,

The method comprises a method step b) in which the reflected portions are detected by means of the image sensor.

The method comprises a method step c) in which a control unit determines a lateral distance between the reflected portions and the control unit adjusts the distance from the object plane to the imaging objective by means of the optical element to minimize the lateral distance. In particular, the control unit is arranged to determine the lateral distance, which is measured in a direction parallel to the object plane, by means of the image captured by means if the image sensor. The control unit may be arranged to minimize the lateral distance until the reflected portions overlap.

According to one embodiment, the optical element comprises a lens array with multiple lenses, and two emitters are assigned to each lens. The lenses may be tunable lenses having an adjustable optical power, wherein the optical of each lens is individually adjustable.

In the method step b) the control unit is arranged to determine a lateral distance between the reflected portions of the beams which are transmitted through the same lens respectively. Thus, the control unit determines a lateral distance value for each pair of beams being assigned to a common lens.

In the method step c) the control unit controls the lenses individually such that the lateral distance of the reflected portions of beams being transmitted through the lens is reduced respectively until the reflected portions of beams being transmitted through a common lens overlap. In particular, the control unit may adjust the optical power of the lenses separately, whereby the object plane may have a different distance to the imaging objective for each lens respectively.

### BRIEF DESCRIPTION OF THE DRAWINGS

Further advantages and advantageous embodiments and further embodiments of the focus system and the method for operating a focus system result from the following embodiment examples shown in connection with the figures.

It shows:

FIGS. 1, 2, 10 and 11 an exemplary embodiment of a focus system in a schematic sectional view;

FIGS. 3a, 3b and 3c an exemplary embodiment of a focus system in a schematic sectional view and a schematic representation of spots depicted in the image plane respectively;

FIGS. 4 and 5, FIGS. 6 and 7 and FIGS. 8 and 9 an exemplary embodiment of a focus system comprising a lens array in a schematic sectional view and a schematic representation of the corresponding spots detected by means of the image sensor.

Elements which are identical, similar or have the same effect are given the same reference signs in the figures. The figures and the proportions of the elements shown in the figures to one another are not to be regarded as to scale. Rather, individual elements may be shown exaggeratedly large for better representability and/or for better comprehensibility.

### DETAILED DESCRIPTION

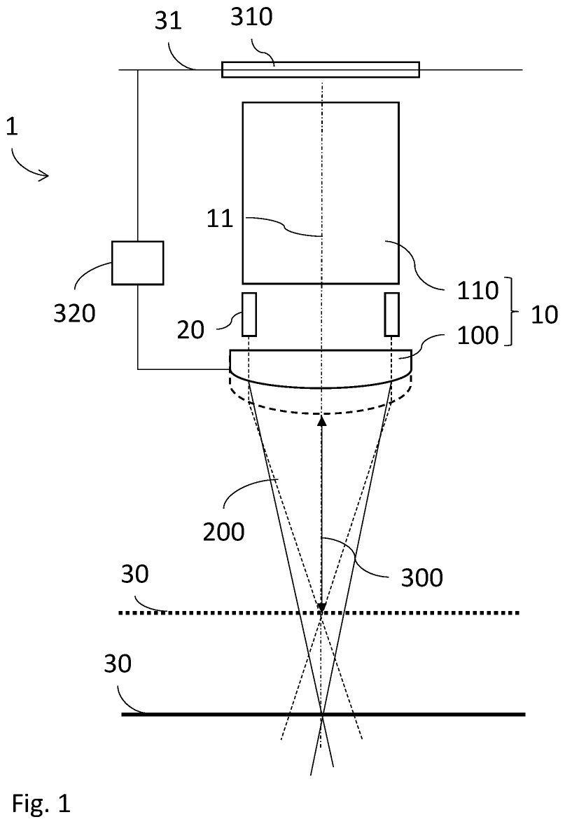

FIG. 1 shows an exemplary embodiment of a focus system in a schematic sectional view. The focus system 1 comprises an imaging objective 10 with an optical element 100 and an optical unit 110. In particular, the optical unit is an optical system which is optimized for imaging objects at infinity distance. Here and in the following infinity distance corresponds to an object distance to the optical unit of at least two meters, preferably at least 5 meters. The imaging objective 10 is arranged to depict an object 3 located in an object plane 30 in an image plane 31, wherein the optical element 100 is arranged to adjust a distance 300 from the object plane 30 to the imaging objective 10.

The focus system comprises two emitters 20 for emitting a beam 200 respectively, wherein the beams 200 are transmitted through the optical element 100. The emitters 20 are arranged between the optical unit 110 and the optical element 100. The emitters emit the beams 200 in a parallel fashion parallel to the optical axis 11 of the optical element through the optical element 100. In this embodiment the optical element 100 is a refractive element. The optical element 100 is a tunable lens having a tunable optical power, wherein the distance from the object plane 30 to the imaging objective 10 is adjustable by tuning the optical power. Alternatively, the optical element 100 may be a reflective optical element.

The beams 200 propagate symmetrically with respect to an optical axis 11 of the optical element 10. The beams are collimated and a diameter of the aperture of the imaging objective 10 is at least two times larger, in particular at least 100 times larger than a diameter of the beams, respectively. The beams 200 intersect at the object plane 30.

The focus system comprises an image sensor 310 which is arranged to capture the object depicted in the image 310 plane by means of the imaging objective 10. The beams impinging on the object generate spots on a surface of the object, wherein the beams are reflected diffusely at these spots. The image sensor is arranged to detect the spots and/or the diffusely reflected portions of the beams

A control unit 320 is arranged to determine a lateral distance between the spots based on the image captured by means of the image sensor 310. The control unit 320 is arranged to control the optical element 100. In particular, the control unit 320 controls the optical element 100 such that the distance of the spots 201 becomes zero. In other words, the spots 201 overlap. In particular, the control unit 320 is arranged to determine if the reflected portions of the beams 200 overlap.

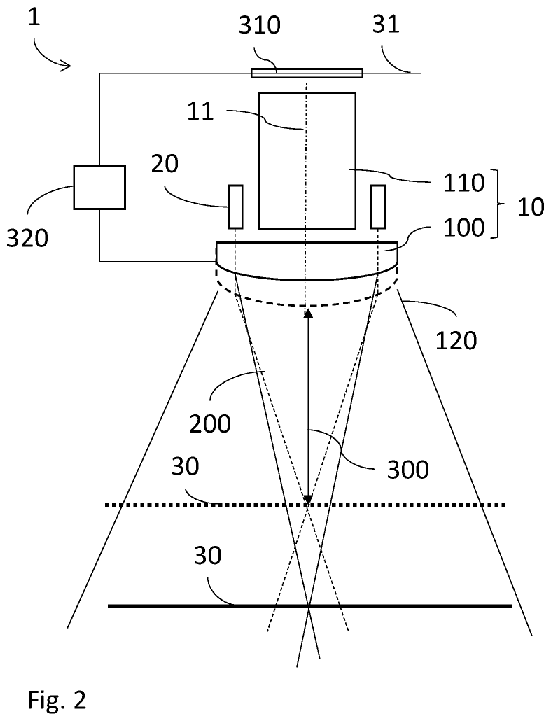

FIG. 2 shows an exemplary embodiment of a focus system 1 in a schematic sectional view. The embodiment shown in FIG. 2 differs from the embodiment shown in FIG. 1 in the arrangement of the emitters 20 and the optical element 100. The diameter of the optical element 100 is larger than the diameter of the optical unit 110. In a protruding portion, the optical element 100 protrudes over the optical unit 110 laterally. Herein, laterally is in direction perpendicular to the optical axis of the imaging objective. Thus, the protruding portion of the optical element is not used for depicting the object. The emitters 20 emit the beams 200 in a parallel fashion parallel to the optical axis of the optical element through the protruding portion of the optical element.

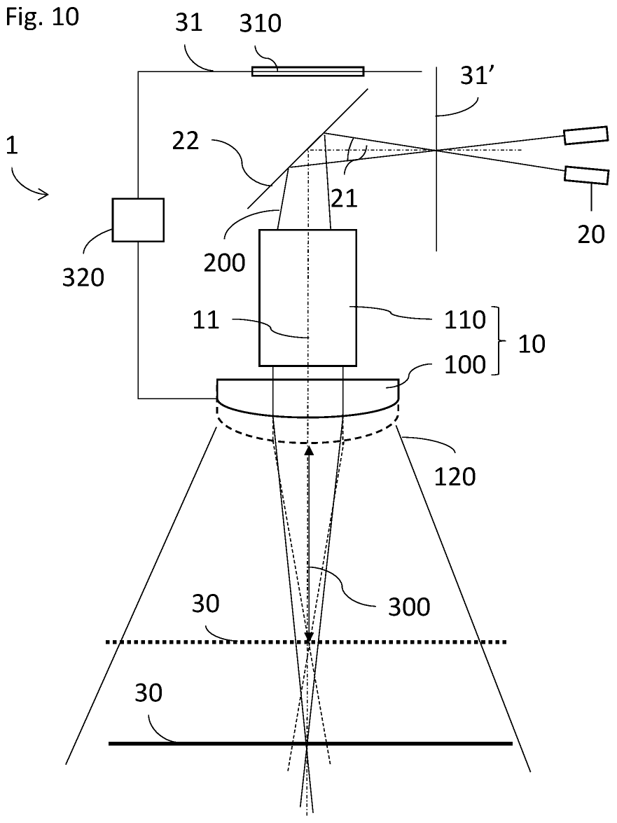

FIG. 10 shows an exemplary embodiment of a focus system in a schematic sectional view. The embodiment in FIG. 10 differs from the embodiment in FIG. 1 in the arrangement of the emitters 20. The focus system comprises a second image plane 31′, which is generated by means of a beam splitter 22, wherein the beam splitter 22 is arranged between the imaging objective 10 and the image sensor 310.

The beams 200 are coupled into the imaging objective 10 from a direction of the second image plane 31′ and the image is captured at the image plane 31. The total track length, starting from the first refractive surface of the imaging objective 10, to the image plane 31 and to the second image plane 31′ is identical. In particular, no refractive elements are arranged between the beam splitter 22 and the image plane 31 and between the beam splitter 22 and the second image plane 31′.

The emitters 20 are arranged such that the beams 20 propagate along a propagation line respectively. The propagation lines are imaginary beam paths extending from the second image plane 31′ to the object plane 30. The propagation lines intersect at the second image plane 31′. A beam angle 21 between the propagation lines is larger than zero degrees, preferably at least 0.01° , and smaller than twice a maximal half-angle of a cone of light that can enter or exit the imaging objective 10. In particular, the beam angle 21 is smaller than the numerical aperture of the imaging objective 10. At the second image plane 31′, both propagation lines have a same angle with respect to the optical axis 11 of the imaging objective 10. In particular, the angle between the propagation lines and the optical axis 11 at the second image plane 31′ is half of the beam angle 21 respectively. In particular, the optical unit may be optimized for any object distance.

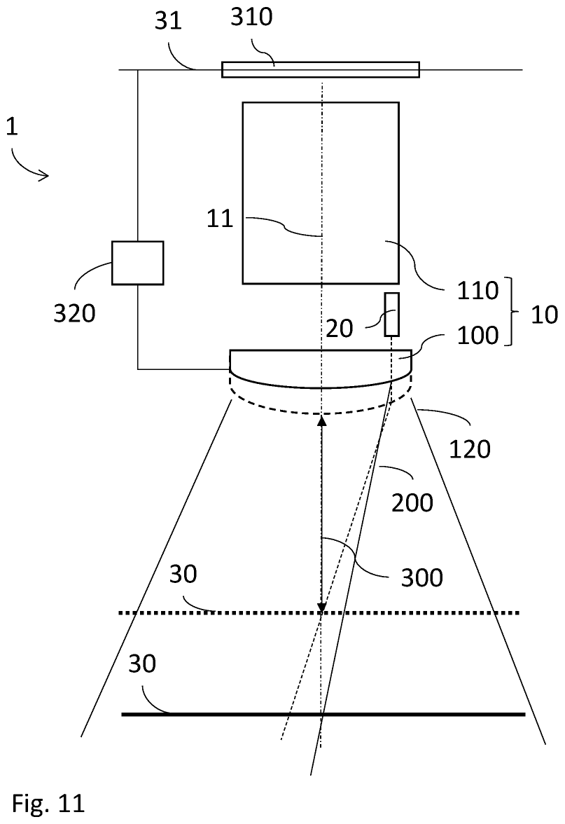

FIG. 11 shows an exemplary embodiment of a focus system in a schematic sectional view. The focus system 1 comprises a single emitter 20 for emitting a beam 200, wherein the beam 200 interacts with the optical element 100 and the deflection of the beam 200 depends on the distance 300 of the object plane 30 to the imaging objective 10. The beam 200 extends obliquely with respect to the optical axis 11 of the imaging objective 10 from the imaging objective 10 towards the object 3. The beam 200 creates a spot on the surface of an object 3, which spot 201 is detectable by means of the image sensor 310 arranged at the image plane 31. By calibration a predefined position of the spot 201 in the filed of view 120 may be linked to the object plane 30. In the present case the predefined position is the point where the optical axis intersects with the object plane. Thus, the predefined position is in the center of the field of view. However, by calibration the predefined position may be anywhere within the field of view. The predefined position refers to a position in the object plane within the field of view. Thus, the predefined position only defines a position in directions perpendicular to the optical axis. The predefined position does not depend on the distance of the object plane 30 to the imaging objective 10.

When the spot 201 is detected at said predefined position the object plane 30 and the surface at which the spot 201 is generated coincide, which means that the imaging objective 10 is focused on said surface of the object 3. In particular, the position of the spot may be determined by determining its center of mass. Additionally, the shape of the spot may be utilized to determine the position of the spot in the field of view.

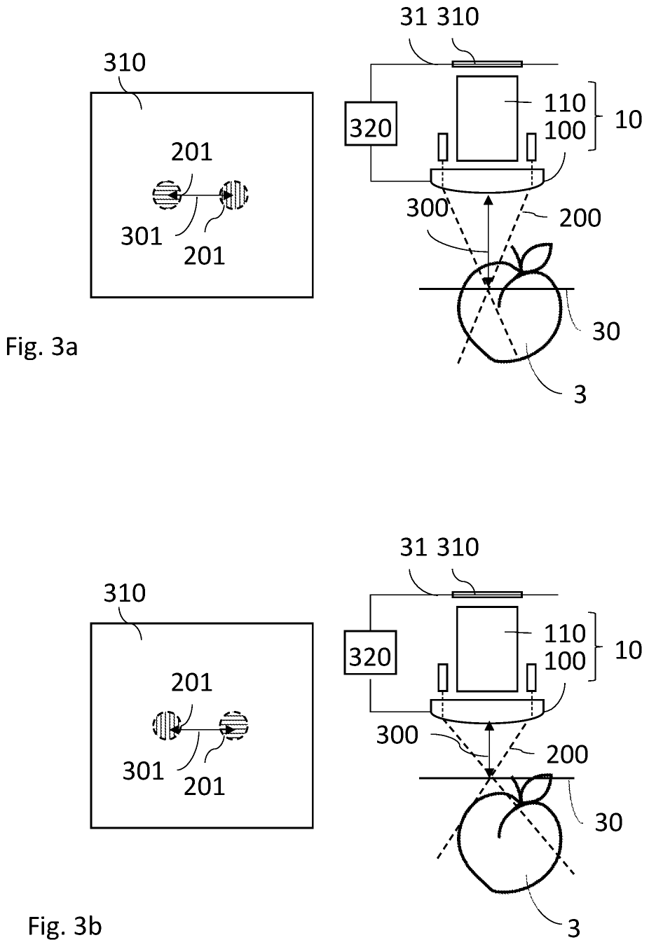

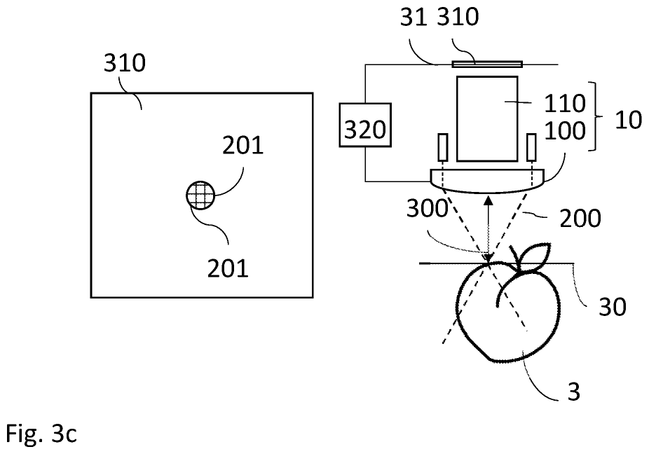

FIGS. 3a, 3b and 3c show an exemplary embodiment of a focus system 1 in a schematic sectional view and a schematic representation of spots 201 depicted in the image plane 31, respectively. As shown in FIG. 3a, the object plane 30 is too far away from the imaging objective 10, whereby the object plane 30 does not coincide with a surface of the object 3. Before intersecting, the beams 200 impinge on the surface of the object at different locations, which results in a lateral distance 301 between the spots 201 generated at the surface of the object 3.

As shown in FIG. 3b, the object plane 30 is too close to the imaging objective 10, whereby the object plane 30 does not coincide with a surface of the object 3. After intersecting, the beams 200 impinge on the surface of the object at different locations, which results in a lateral distance 301 between the spots 201 generated at the surface of the object 3.

As shown in FIG. 3c, the object plane 30 has a well adjusted distance 300 to the imaging objective 10, whereby the object plane 30 coincides with a surface of the object 3. The beams 200 impinge on the surface of the object at a common location, which results in overlapping spots 201 generated at the surface of the object 3.

As shown in the FIGS. 3a to 3c, the beams and their reflected portion may differ in at least one property, which is illustrated by horizontal and vertical line patterns in the spots 201. This optical property may be a the wavelength range of the electromagnetic radiation, the modulation of the light or the phase of the modulation of the light. The optical property allows to determine if the object plane is too far from imaging objective 10 or too close to the imaging objective 10, because the spots permute their relative position. When the object plane 30 is too far away, the spot with the vertical line pattern is on the right-hand side and the sport with the horizontal line pattern is on the left-hand side (FIG. 3a). When the object plane is too close, the spot with the horizontal line pattern is on the right-hand side and the sport with the vertical line pattern is on the left-hand side (FIG. 3b). Thus, the difference of optical property of the beams enables to determine how the optical element 100 must be adjusted to focus on the surface of the object 3. Hence, having distinguishable spots 201 simplifies and accelerates the focusing process.

In particular, the FIGS. 3a, 3b and 3c show an exemplary embodiment of a method for operating the focus system 1 comprising: the imaging objective 10 with optical element 100, two emitters 20 for emitting the collimated beams 200 respectively, the image sensor 310 for capturing an image of the object at the image plane 31 and a control unit 320. The imaging objective 10 is arranged to depict an object 3 located in the object plane 30 in the image plane 31. The optical element 100 interacts with the beams 200 by transmission, and the beams intersect at the object plane 30. The optical element 100 is arranged to adjust a distance 300 from the object plane 30 to the imaging objective 10.

The method comprises a method step a), in which the collimated beams are emitted by means of the emitters 20, wherein the collimated beams 200 propagate through the optical element 100. The beams 200 impinge on a surface of the object 3 and the beams 3 are reflected diffusely at the surface of the object 3, wherein the diffusely reflected portions of the beams 200 propagate through the imaging objective 10, in particular through the optical element 100, to the image sensor 310. In particular, the diffusely reflected portions are conceivable as spots 201 in the image plane 31.

In a method step b), the reflected portions are detected by means of the image sensor 310.

In a method step a) a lateral distance 301 between the reflected portions/spots 201 is determined by means of the control unit 320. The distance from the object plane 30 to the imaging objective 10 is adjusted by means of the optical element 100 to minimize the lateral distance 301. In particular, the object distance 300 is adjusted until the spots 201 overlap.

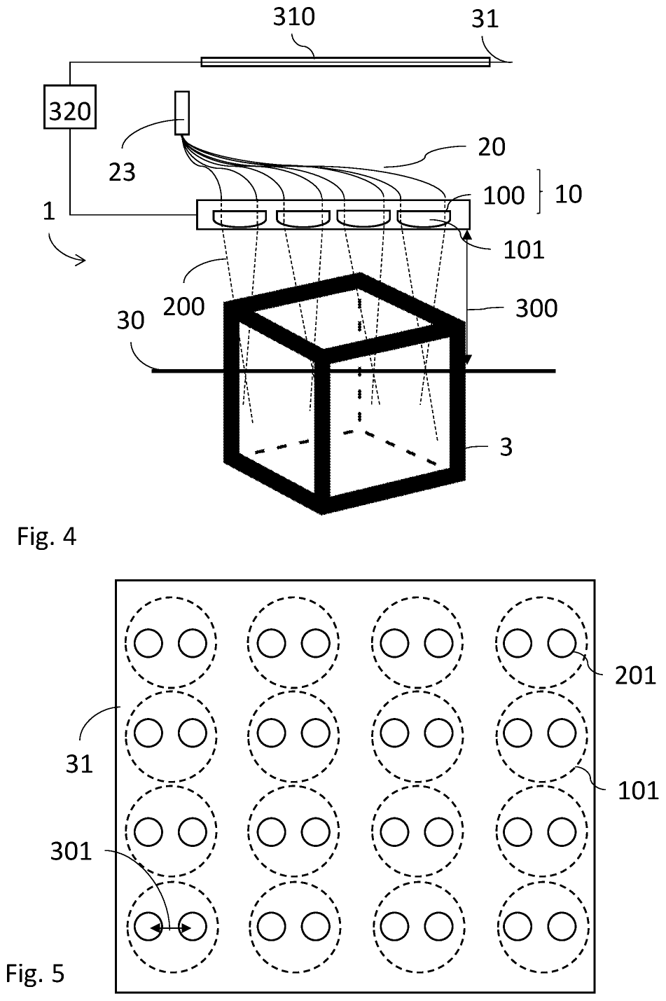

FIG. 4 shows an exemplary embodiment of a focus system 1 comprising a lens array 100 in a schematic sectional view and FIG. 5 shows a schematic representation of the corresponding spots 201 detected by means of the image sensor 310 in the image plane. The focus system 1 comprises the optical element with the lens array with multiple lenses. Two emitters 20 are assigned to each lens 101. Of the lens array 100. The emitters 20 are optical fibers, which are attached to the optical element 100. A light source 23 is arranged to generate the light which is coupled into the optical fibers.

The object 3 has a flat surface extending parallel to the object plane 30, wherein the distance 300 of the object plane to the imaging objective 10 is the same for all lenses 101. Thus, the lateral distance 301 between the spots 201 which result from beams 200 which have passed through a common lens 101 of the lens array.

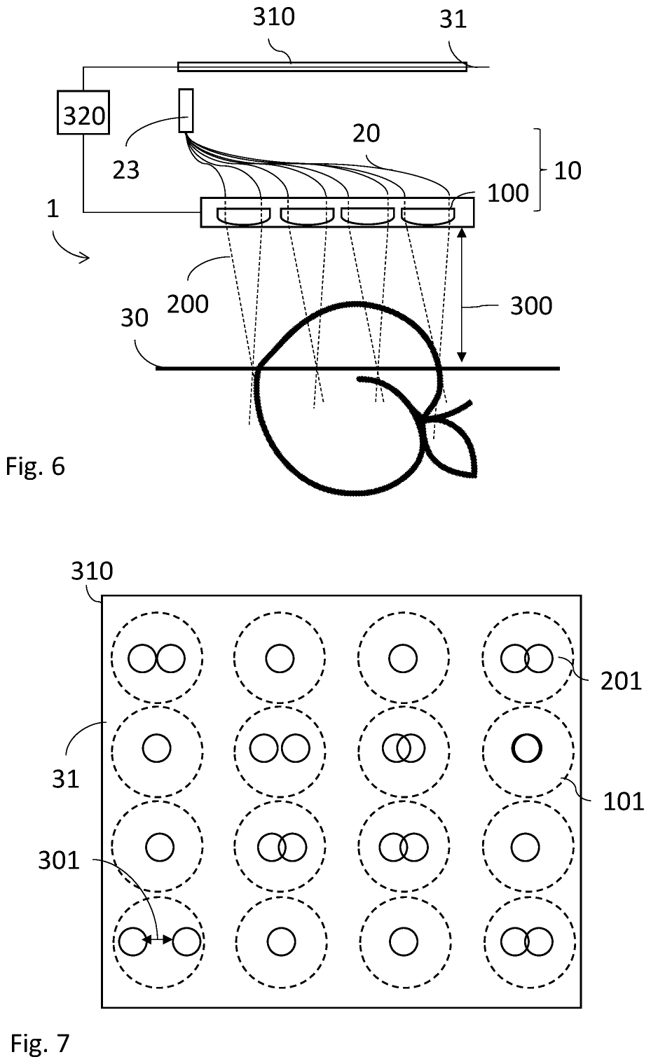

FIGS. 6 and 7 show the same embodiment as in FIGS. 4 and 5, wherein the object has a curved surface facing the imaging objective. The distance 300 is the same for all lenses 101 of the lens array. The varying distance of the surface of the object 3 results in different lateral distances 301 between spots 201 which result from beams 200 passing through a common lens 101. The lateral distance 101 is proportional to the distance between the surface of the object 3 and the imaging objective 10. Thus, the control unit 320 may be arranged to derive a surface profile from the lateral distances 301 of the spots 201. In particular, a measurement at a single object distance 300 does not provide a distinct measurement result, because the lateral distance 301 of spots 201 is the same for two distance values of the surface of the object 3 to the imaging objective 10. Thus, for an unambiguous result of the measurement of the surface profile by means of the focus system, at least two measurements for two different distances 300 of the object plane to the imaging objective 10 or two different distances of the surface of the objective 3 to the imaging objective are required.

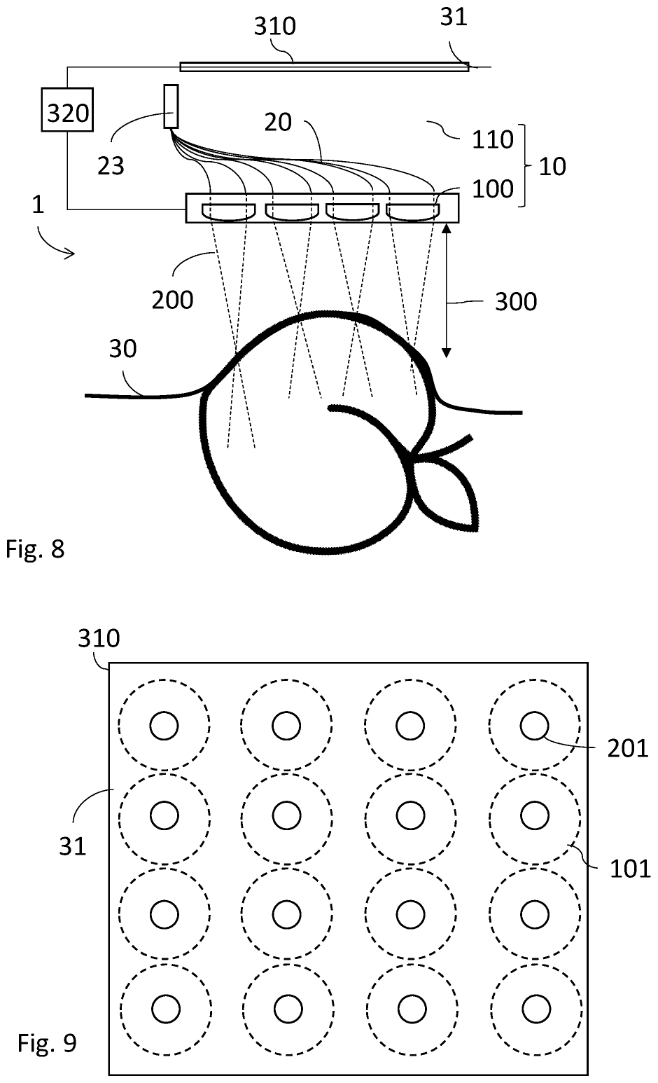

FIGS. 8 and 9 show the same embodiment as in FIGS. 6 and 7, wherein the distance 300 of the lenses 101 of the lens array is adjusted individually for each lens 101. For example, in a method step b) the control unit 320 determines a lateral distance 301 between the reflected portions/spots 201 of the beams 200 which are transmitted through the same lens 101 respectively.

In method step c) the control unit 320 controls the lenses 101 individually such that the lateral distance 301 of the reflected portions of beams 200 being transmitted through a common lens 100 is reduced respectively until the reflected portions/spots 201 of beams 200 being transmitted through a common lens 100 overlap. Each lens 101 depicts a portion of the object 3, wherein the depicted portions of the object 3 may be stitched together by means of the image sensor 310 and the control unit 320. Thus, a focused imaged of all portions is achieved, wherein the surface of the object 3 facing the imaging objective 10 may be curved. As shown in FIG. 9, all lenses 101 are adjusted to be in focus, all spots 201 originating from beams transmitted through a common lens 101 overlap.

The invention is not limited to the embodiments by the description based thereon. Rather, the invention encompasses any new feature as well as any combination of features, which in particular includes any combination of features in the claims, even if that feature or combination itself is not explicitly stated in the claims or embodiments.

### LIST OF REFERENCE SIGNS

1 Focus system

2 Object

10 Imaging objective

11 Optical axis

100 Optical element

110 Optical unit

120 Field of view

20 Emitter

21 Beam angle

22 Beam splitter

23 Light source

200 Beam

201 spot

30 Object plane

31 Image plane

31′ Second image plane

300 Distance

301 Lateral distance

310 Image sensor

320 Control unit

We claim:

1. Focus system comprising
an imaging objective with an optical element and a field of view,
an emitter for emitting a beam, wherein
the imaging objective is arranged to depict an object located in an object plane in an image plane,
the optical element is arranged to adjust a distance from the object plane to the imaging objective,
the beam is transmitted through or reflected by the optical element, and
the beam intersects the object plane at a predefined position within the field of view.

2. Focus system according to claim 1, comprising two emitters for emitting a beam respectively, wherein the beams are transmitted through or reflected by the optical element, and the beams intersect at the object plane.

3. Focus system according to claim 1, wherein the beam is collimated and wherein a diameter of the aperture of the imaging objective is at least two times larger than a diameter of the beam.

4. Focus system according to claim 1 comprising an image sensor which is arranged to capture the object depicted in the image plane by means of the imaging objective.

5. Focus system according to claim 4, wherein the image sensor is arranged to detect reflected portions of the beam, which is reflected at a surface of the the object towards the image sensor.

6. Focus system according to claim 2, comprising a control unit, wherein the control unit is arranged to determine a lateral distance between the reflected portions based on the image captured by means of the image sensor.

7. Focus system according to claim 5, comprising a control unit, wherein the control unit is arranged to determine a difference between the reflected portion and the predefined position based on the image captured by means of the image sensor.

8. Focus system according to claim 1, wherein the optical element is a tunable lens having a tunable optical power, wherein the distance from the object plane to the imaging objective is adjustable by tuning the optical power.

9. Focus system according to claim 2, wherein the beams propagate symmetrically with respect to an optical axis of the optical element.

10. Focus system according to claim 2, wherein the optical element comprises a lens array with multiple lenses, and
two emitters are assigned to each lens.

11. Method for operating a focus system comprising:
an imaging objective with an optical element,
the imaging objective is arranged to depict an object located in an object plane in an image plane,
an emitter for emitting a collimated beam, wherein
the optical element interacts with the beam by transmission or reflection,
the beam intersects the object plane at a predefined position, and
the optical element is arranged to adjust a distance from the object plane to the imaging objective,
comprising the steps of
a) emitting the collimated beam by means of the emitter, wherein the collimated beam propagates through the optical element or is reflected at the optical element, the beam impinges on a surface of the object and the beam is reflected diffusely at the surface of the object, wherein the diffusely reflected portion of the beam propagates through the imaging objective, in particular through the optical element, towards an image sensor,
b) detecting the position of the reflected portion by means of the image sensor,
c) determining an actual position of the reflected portion by means of a control unit and adjusting the distance from the object plane to the imaging objective by means of the optical element to minimize a difference between the actual position and the predefined position.

12. Method according to claim 11, the optical element comprising a lens array with multiple lenses, and multiple emitters, wherein
one emitter is assigned to each lens,
in method step b) the control unit is arranged to determine the actual positions of reflected potions of each beam, and
in method step c) the control unit controls the lenses individually such that the difference between the actual position of the reflected portions and the predefined position is reduced respectively.

13. Method according to claim 12, wherein
two emitters are assigned to a lens,
in method step b) the control unit is arranged to determine a lateral distance between the reflected portions of the beams which are transmitted through the same lens respectively, and
in method step c) the control unit controls the lenses individually such that the lateral distance of the reflected portions of beams being transmitted through the lens is reduced respectively until the reflected portions of beams being transmitted through a common lens overlap.
